(19) United States
(12) Patent Application Publication
(10) Pub. No.: US 2003/0140972 A1
(43) Pub. Date: Jul. 31, 2003

(54) Fluid line connecting system

(76) Inventor: Donald A. Halvorsen, Alberta (CA)

Correspondence Address: Vermette & Co., Box 40 Granville Square, Suite 200-230 Granville Street, Vancouver, BC, V6C 1S4, CA

(21) Appl. No.: 10/243,751

(22) Filed: Sep. 16, 2002

(30) Foreign Application Priority Data
Sep. 17, 2001 (CA) 2,357,558

(51) Int. Cl. F16L 37/32

(52) U.S. Cl. 137/614.04

(57) ABSTRACT

A coupling system is disclosed for coupling fluid lines, which has no exposed moveable parts. The coupling system is resistant to accidental uncoupling due to vibration, impact or other physical hazards, resistant to dirt, debris, spills and other environmental hazards, can be coupled and uncoupled quickly and easily, and is resistant to accidental uncoupling.

### BACKGROUND OF THE INVENTION

There are many applications, such as farming, construction, transportation, undersea applications, etc., in which couplings between fluid or gas lines are exposed to harsh environments. In such environments such couplings are likely to become accidentally uncoupled damaged by physical stresses. In addition, such couplings may become jammed or may otherwise malfunction if they or their components are penetrated by dirt, dust, water, or other environmental contaminants.

Although the prior art comprises several coupling systems (e.g. U.S. Pat. No. 5,889,228 issued to Smith, III; U.S. Pat. No. 5,546,986 issued to Clark, II et al.; U.S. Pat No. 4,819,692 issued to Olson et al.; 5,016,671 issued to Barwise; and U.S. Pat No. 5,647,398 issued to Giesler) intended capable of functioning in a variety of environments, all such systems suffer from various drawbacks. Some coupling systems of the prior art are unnecessarily complex or have external moving parts, resulting in a greater likelihood of failure or malfunction under difficult conditions. Such coupling systems additionally tend to be slow or difficult to couple and uncouple. Yet other coupling systems are prone to accidental uncoupling.

Accordingly, it is an object of the present invention to provide means for coupling fluid or gas lines that is resistant to accidental uncoupling due to vibration, impact or other physical hazards. It is a further object of the present invention to provide a means for coupling fluid or gas lines that is resistant to dirt, debris, spills and other environmental hazards, and which can be coupled and uncoupled quickly and easily. It is a further object of the present invention to provide a coupling system that is has no external moving parts. It is a further object of the present invention to provide a coupling system that is resistant to accidental uncoupling.

### SUMMARY OF THE INVENTION

The present invention comprises a coupling system for connecting fluid or gas lines, comprising a first coupler and a second coupler, each of the first and second couplers having a coupling end and a fluid line connecting end. Each coupler has an internal bore extending from the coupling end to the fluid line connecting end, and the internal bore has a mouth at the coupling end. Each coupler has a valve stem, wherein a first end of the valve stem comprises a coupling head of a size and shape such that said coupling head fits into the mouth of the internal bore to form a fluid tight seal. The fluid tight seal is broken upon movement of the valve stem along a line parallel to the longitudinal axis of the internal bore.

Each coupler has a support member located inside the internal bore and coupled to the valve stem. The support member is operative to support the valve stem and is of a size and shape such that fluid passing through the internal bore passes around the support member. The support member and the valve stem of the first coupler are coupled such that the valve stem cannot rotate relative to the first coupler. A portion of the valve stem of the second coupler is threaded and the support member of the second coupler has a threaded hole operative to receive the threaded portion of the valve stem.

The first coupler and the second coupler are couplable by engagement of the coupling end of the first coupler with the coupling end of the second coupler and contrarotation of the first and second couplers about a common longitudinal axis. When the first and second couplers are engaged and contrarotated, the coupling head of the first coupler is operative to engage the coupling head of the second coupler and to cause the valve stem of the second coupler to rotate in unison with the first coupler, thereby causing movement of both valve stems toward the fluid line connecting end of the first coupler and causing the fluid tight seals between the coupling heads and the mouths of the internal bores to be broken such that the internal bores are placed in fluid communication.

In one embodiment the first coupler is a male coupler and said second coupler is a female coupler. However, in an alternative embodiment the first coupler is a female coupler and the second coupler is a male coupler.

In an alternative embodiment, the mouth of the internal bore of the second coupler comprises a sliding ring. When said coupling ends of the first and second couplers are engaged and contrarotated the coupling end of said first coupler comes into contact with the sliding ring and causes the sliding ring to slide toward the fluid line connecting end of the second coupler.

### BRIEF DESCRIPTION OF THE DRAWINGS

Further features and advantages will be apparent from the following detailed description, given by way of example, of preferred embodiments taken in conjunction with the accompanying drawings, wherein:

FIG. 1 shows a cutaway side view of the coupling system of the present invention;

FIG. 2 is an axial view of the male coupler from the fluid line connecting end;

FIG. 3 is an axial view of the male coupler from the coupling end;

FIG. 4 is an axial view of the female coupler from the coupling end;

FIG. 5 is an axial view of the female coupler from the fluid line connecting end;

FIG. 6 shows a cutaway side view of an alternate embodiment of the coupling system of the present invention;

FIG. 7 is an axial view of the female coupler of the alternate embodiment from the coupling end; and

FIG. 8 is a side view detail of the grooves of the male couplers.

### DETAILED DESCRIPTION OF THE DRAWINGS

Referring to FIG. 1, the coupling system comprises two parts: a male coupler 10 and a female coupler 20. The male coupler 10 has an approximately cylindrical shape with a coupling end and a fluid line connecting end. The male coupler 10 has an internal bore 12 extending from the coupling end to the fluid line connecting end. The internal bore 12 is bisected by a support member 34, which is of a size and shape such that it allows fluid to pass around it and through the internal bore 12 when the coupling system is in operation. One end of valve stem 30 is slidably coupled to the support member 34 in a manner such that valve stem 30 cannot rotate relative to the support member 34 and male coupler 10. The other end of the valve stem 30 comprises a head 38, which fits into the mouth of internal bore 12 such that a fluid tight seal is formed with O-ring 36 when the male coupler is closed (i.e. not engaged with the female coupler 20). The head 38 of valve stem 30 is urged into the closed position against the mouth of the internal bore 12 and O-ring 36 by valve spring 32.

The fluid line connecting end of the male coupler 10 is threaded so that it can be coupled to connecting nut 44 or a pipe or hose. Compression of the O-ring 46 between the male coupler 10 and the connecting nut 44 forms a fluid-tight seal.

The female coupler 20 has an approximately cylindrical shape with a coupling end and a fluid line connecting end. The female coupler 20 has an internal bore 52 extending from the coupling end to the fluid line connecting end. The internal bore 52 of the female coupler 20 is bisected by a support member 62, which has a threaded hole parallel to the internal bore 52. The support member 62 is of a shape and size such that it allows fluid to pass around it and through the internal bore 52 when the coupling system is in operation. The threaded hole receives the threaded end of valve stem 60, such that rotation of the valve stem 60 within the threaded hole of the support member 62 results in movement of the valve stem 60 along the longitudinal axis of the internal bore 52.

The other end of the valve stem 60 comprises a head 64. When the female coupler 20 is closed (i.e. not engaged with the male coupler 10), the head 64 fits into the mouth of internal bore 52 at the coupling end of the female coupler 20, such that a fluid tight seal is formed with O-ring 66.

The fluid line connecting end of the female coupler 20 carries a screw thread to connect to a connecting nut 90 or a pipe or hose. O-ring 92 forms a fluid-tight seal between the female coupler 20 and connecting nut 90.

The head 38 of valve stem 30 of the male coupler 10 has a cavity 40. The head 64 of valve stem 60 of the female coupler 20 has a bit 72 that is complementary in shape to the cavity 40. When the male coupler and the female coupler are engaged the cavity 40 receives the bit 72. The cavity 40 and the bit 72 are each of a shape such that they have non-circular cross-sections when the couplers 10, 20 are viewed axially. When the bit 72 and the cavity 40 are engaged, and the male coupler 10 and the female coupler 20 are rotated in opposite directions about their common longitudinal axis (i.e. contrarotated), the valve stems 30, 60 rotate in unison with the female coupler 20 and opposite the male coupler 10.

When the male 10 and female coupler 20 are engaged the O-ring 68 is compressed between the coupling ends of the male and female couplers 10, 20 to create a fluid tight seal.

Referring to FIGS. 1 and 2, an axial view of the fluid line connecting end of the male coupler 10 is shown. The support member 34 is shaped and positioned such that fluid can pass through the axially oriented bore and around the support member 34. Also shown is the end of valve stem 30 slidably engaged by the hole of the support member 34.

Referring to FIGS. 1 and 3, an axial view of the coupling end of the male coupler 10 is shown. O-ring 36 forms a fluid tight seal between the head 38 of the valve stem 30 and the mouth of the internal bore 12. The cavity 40 of the head 38 of the valve stem 30 is operative to receive the bit 72 of the female coupler 20. In the present embodiment the bit has a rectangular cross-section however the bit may take any of a number shapes that is of non-circular cross-section when the coupling system of the present invention is viewed axially.

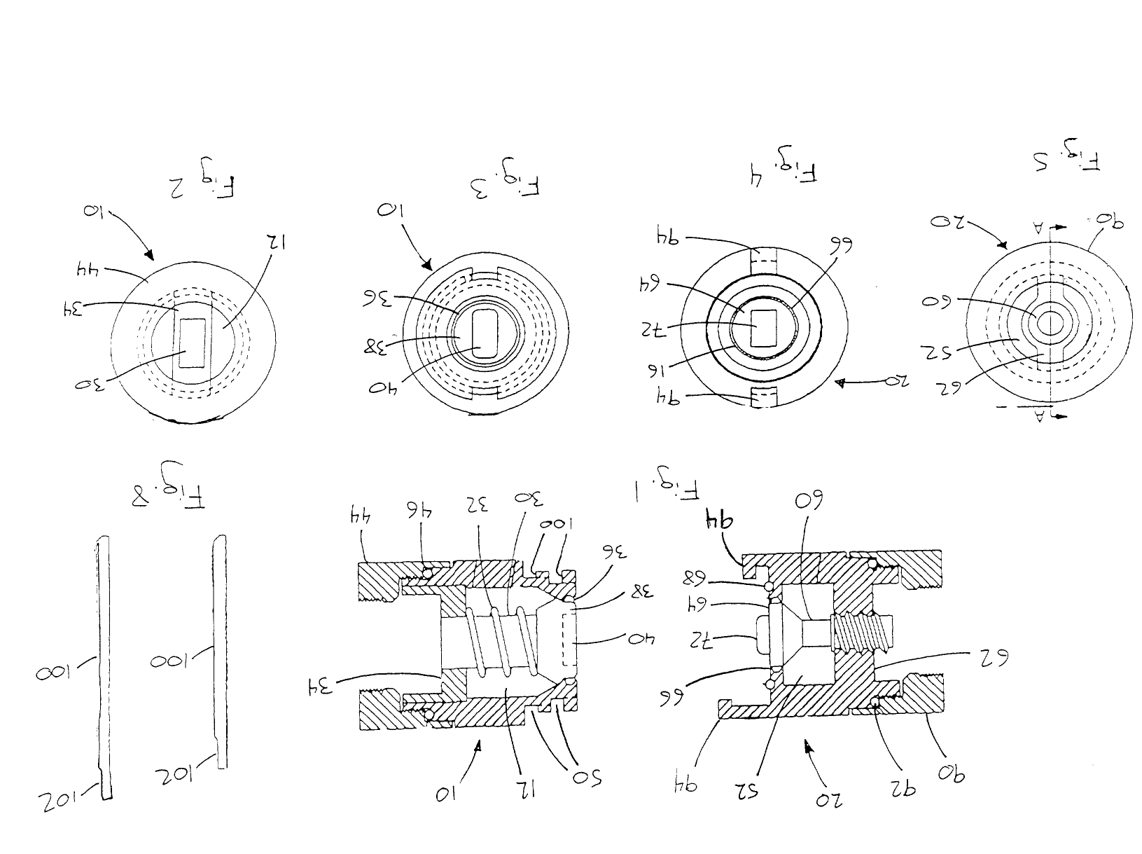

Referring to FIGS. 1 and 4, an axial view of the coupling end of the female coupler 20 is shown. O-ring 66 forms a fluid tight seal between the head 64 of the valve stem 60 and the mouth of the internal bore 52. The female coupler 20 has a bit 72 that has a shape complementary to that of the cavity 40 of the male coupler 10 such that the bit is operative to engage the cavity 40 of the male coupler 10.

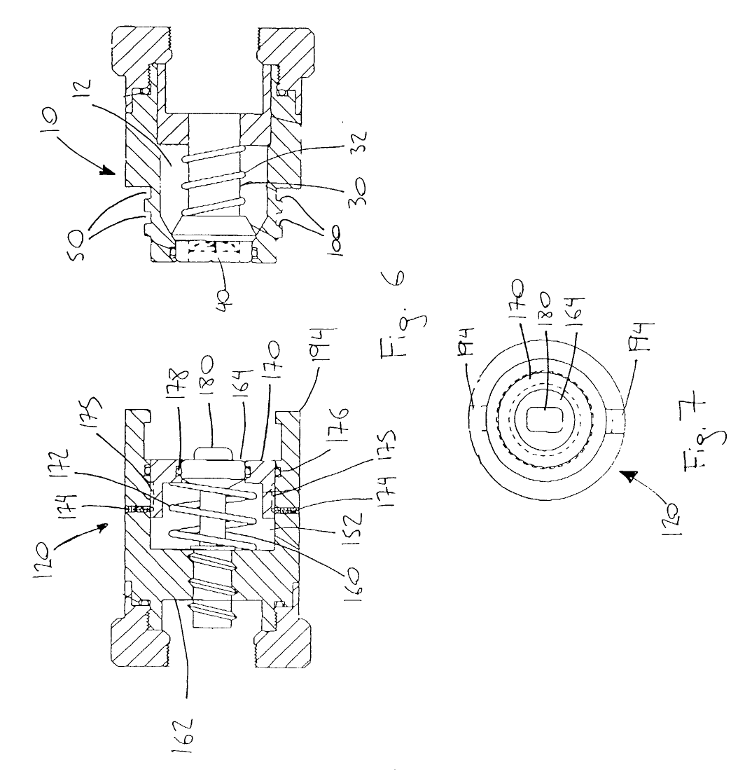

Referring to FIG. 5, an axial view of the fluid line connecting end of the female coupler 20 is shown. The threaded end of the valve stem 60 is shown passing through the threaded hole of support member 62.

Referring to FIGS. 1, 3 and 4, the coupling end of the male coupler 10 has two grooves 50 extending about the circumference of the male coupler. The coupling end of the female coupler 20 has two claws 94, each of which is operative to engage one of the grooves 50 when the coupling ends of the male and female couplers 10, 20 are brought together. As the male coupler is rotated relative to the female coupler, the claws 94 pass along the grooves 50.

In the preferred embodiment, the claws 94 reach the respective ends of the grooves 50 after one rotation of the male coupler 10 relative to the female coupler 20. Referring to FIG. 8, a detailed view of the groove sidewalls 100 of each of the grooves 50 that is nearest the coupling end of the male coupler 10 is shown wherein, at the end of each of the grooves 50 the sidewall 100 has a small depression 102. Upon reaching the end of the grooves 50, the claws 94 enter the small depressions 102 causing the pressure between the male and female couplers 10, 20 to be released slightly, resulting in a locking action.

In the embodiment of the coupling system of the present invention that is shown in FIGS. 1 and 8 the grooves 50 extend about the circumference of the male coupler so as to define a circular plane perpendicular to the longitudinal axis of the male coupler 10. However, in an alternative embodiment the grooves 50 extend about the circumference of the male coupler 10 in a helical manner so as to define a screw thread. In this alternative embodiment the male and female couplers 10, 20 are coupled by screw action, whereby, as the male and female couplers 10, 20 are contrarotated they are drawn together.

Referring to FIGS. 1-5, in operation, the coupling ends of the male and female couplers 10, 20 are brought together such that the bit 72 of the female coupler 20 engages the cavity 40 of the male coupler 10. When the male coupler 10 is rotated relative to the female coupler 20 the valve stem 60 rotates in unison with the male coupler 10 and against the female coupler 20. Rotation of the valve stem 60 relative to the female coupler 20 causes the valve stem 60 to move axially towards the male coupler 10. The axial movement of the valve stem 60 causes the valve stem 30 to move axially away from the female coupler 20 and the valve spring 32 to be compressed. Axial movement of the valve stems 30, 60 breaks the fluid tight seals between the heads 38, 64 of the valve stems 30, 60 and the mouths of the internal bores 12, 52 of the male and female couplers 10, 20 respectively. In this manner the internal bores 12, 52 of the male and female couplers 10, 20 are placed in fluid communication, allowing fluid to pass through the coupling system.

Although in the present embodiment the male coupler 10 carries the grooves 50 and the female coupler has the claws 94, it is obvious to those skilled in the art that other means may be employed to lock the male and female couplers 10, 20 together upon rotation.

Although the engagement mechanism of the coupling heads 38, 64 of the embodiment of FIG. 1 comprises a bit 72 and a cavity 40, it is obvious to a person skilled in the art that alternative engagement mechanisms, such as magnetized coupling heads, could be used.

Referring to FIGS. 6 and 7, in an alternate embodiment of the coupling system the female coupler 120 has an approximately cylindrical shape with a coupling end and a fluid line connecting end. The female coupler 120 has an internal bore 152 extending from the coupling end to the fluid line connecting end of female coupler 120. The internal bore 152 of the female coupler 120 is bisected by a support member 162, which has a threaded hole parallel to the internal bore 152. The support member 162 is of a shape and size such that it allows fluid to pass around it and through the internal bore 152 when the coupling system is in operation. The threaded hole receives the threaded end of valve stem 160, such that rotation of the valve stem 160 results in movement of the valve stem 160 along the longitudinal axis of the internal bore 152.

The coupling end of the female coupler 120 comprises a sliding ring 170. O-ring 176 creates a fluid tight seal between the sliding ring 170 and the wall of the internal bore 152. O-ring 178 creates a fluid tight seal between the sliding ring 170 and the head 164 of valve stem 160. The sliding ring 170 is kept closed, that is, it is forced toward the coupling end of the internal bore 152, by spring 172. Set screws 174, which protrude into grooves 175 of the sliding ring 170, prevent spring 172 from pushing the sliding ring 170 out of the internal bore 152.

Referring to FIGS. 6 and 7, in operation, the coupling ends of the male and female couplers 10, 120 are brought together such that the bit 180 of the female coupler 120 engages the cavity 40 of the male coupler 10. When the male coupler 10 and the female coupler 120 are engaged and contrarotated, the sliding ring 170 is depressed spring 172 is compressed as the claws 194 travel along the grooves 50 (depression of the sliding ring is limited by set screws 174). As the couplers 10, 120 are contrarotated, the valve stem 160 rotates in unison with the male coupler 10 and against the female coupler 120. Rotation of the valve stem 160 relative to the female coupler 120 causes the valve stem 160 to move axially towards the male coupler 10. The axial movement of the valve stem 160 causes the valve stem 30 of the male coupler 10 to move axially away from the female coupler 120 and the valve spring 32 of the male coupler 10 to be compressed. Axial movement of the valve stems 30, 160, and depression of the sliding ring 170 cause the fluid tight seal of O-ring 178 to be broken. In this manner the internal bores 12, 152 of the male and female couplers 10, 120 are placed in fluid communication, allowing fluid to pass through the coupling system.

Although in both of the embodiments described above, the male coupler 10 carries the grooves 50 and the female coupler 20, 120 has the claws 94, 194, it is obvious to those skilled in the art that other means may be employed to lock the male 10 and female 20, 120 couplers together by rotation of the male coupler 10 relative to the female coupler 20, 120.

In an alternate embodiment of the coupling system of FIG. 1, the valve stem 60 having the threaded end and the support member 62 having the threaded hole are located in the male coupler 10, and the valve stem 30, valve spring 32 and support member 34 are located in the female coupler 20. Similarly, referring to the embodiment of FIG. 6, the sliding ring 170, the valve stem 160 having the threaded end, and the support member 162 having the threaded hole are located in the male coupler 10, and the valve stem 30, valve spring 32 and support member 34 are located in the female coupler 120.

In an alternate embodiment of the present invention, the support member 62, 162, 34 need not bisect the internal bore 12, 52, 152 of the couplers 10, 20, 120. For example, the support member 62, 162, 34 may contact the surface of the internal bore 12, 52, 152 at only one point or at three points rather than at two points as shown in FIGS. 1 and 6.

While this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

I claim:

1. A coupling system for connecting fluid lines, comprising a first coupler and a second coupler, each of said first and second couplers having a coupling end and a fluid line connecting end, each of said first and second couplers comprising:
a) an internal bore extending from said coupling end to said fluid line connecting end, said internal bore having a mouth at said coupling end;
b) a valve stem, wherein a first end of said valve stem comprises a coupling head of a size and shape such that said coupling head fits into said mouth of said internal bore to form a fluid tight seal, wherein said fluid tight seal is broken upon movement of said valve stem along a line parallel to a longitudinal axis of said internal bore;
c) a support member located inside said internal bore and coupled to said valve stem, said support member operative to support said valve stem, wherein said support member is of a size and shape such that fluid passing through said internal bore passes around said support member;
wherein said support member and said valve stem of said first coupler are coupled such that said valve stem of said first coupler cannot rotate relative to said first coupler; and
wherein a portion of said valve stem of said second coupler is threaded and wherein said support member of said second coupler has a threaded hole operative to receive said threaded portion of said valve stem;
wherein said first coupler and said second coupler are couplable by engagement of said coupling end of said first coupler with said coupling end of said second coupler and contrarotation of said first and second couplers;
wherein, when said first and second couplers are engaged and contrarotated, said coupling head of said first coupler is operative to engage said coupling head of said second coupler and to cause said valve stem of said second coupler to rotate in unison with said first coupler, thereby causing movement of said valve stems of said first and second couplers toward said fluid line connecting end of said first coupler and causing said fluid tight seals between said coupling heads and said mouths of said internal bores to be broken such that said internal bores are placed in fluid communication.

2. The coupling system of claim 1, wherein said first coupler is a male coupler and said second coupler is a female coupler.

3. The coupling system of claim 1, wherein each of said first and second couplers further comprise an O-ring on an inside of said mouth of said internal bore, each of said O-rings operative to form a fluid tight seal between respective ones of said coupling heads and said mouths of said internal bores.

4. The coupling system of claim 1, wherein said first and second couplers are coupled by rotation of said first coupler through 360 degrees relative to said second coupler.

5. The coupling system of claim 1, wherein said first coupler further comprises a valve spring operative to urge said valve stem of said first coupler against said mouth of said internal bore of said first coupler.

6. The coupling system of claim 1, wherein each of said support members forms an integral part of a respective one of said first and second coupler.

7. The coupling system of claim 1, wherein said first and second couplers are coupled a screw action.

8. The coupling system of claim 1, wherein said mouth of said internal bore of said second coupler comprises a sliding ring, wherein when said coupling ends of said first and second couplers are engaged and contrarotated said coupling end of said first coupler comes into contact with said sliding ring and causes said sliding ring to slide toward said fluid line connecting end of said second coupler.

9. The coupling system of claim 8, wherein said second coupler further comprises a spring, said spring operative to urge said sliding ring toward said coupling end of said internal bore of said second coupler.

10. The coupling system of claim 8, wherein said second coupler further comprises at least one set screw, said set screw operative to limit movement of said sliding ring.

11. The coupling system of claim 8, wherein said second coupler further comprises an O-ring in said internal bore, said O-ring operative to create a fluid tight seal between said sliding ring and said internal bore.

12. The coupling system of claim 1, wherein said fluid line connecting ends of said first and second couplers are threaded such that they are couplable by screw action to one of a fluid line connecting nut, a pipe, and a hose.

13. The coupling system of claim 1, wherein said valve stems of said first and second couplers are substantially parallel to respective longitudinal axes of said internal bores of said first and second couplers.

14. The coupling system of claim 1, wherein said support members each bisect a respective one of said internal bores.

15. A method of coupling fluid lines, comprising:
a) providing first and second couplers, each of said first and second couplers having a coupling end and a fluid line connecting end, each of said first and second couplers comprising:
i. an internal bore extending from said coupling end to said fluid line connecting end, said internal bore having a mouth at said coupling end;
ii. a valve stem, wherein a first end of said valve stem comprises a coupling head of a size and shape complementary to that of said mouth of said internal bore such that a fluid tight seal is formed therebetween, wherein said fluid tight seal is broken upon movement of said valve stem along a line parallel to a longitudinal axis of said internal bore;
iii. a support member located inside said internal bore and coupled to said valve stem, said support member operative to support said valve stem, wherein said support member is of a size and shape such that fluid passing through said internal bore passes around said support member;
wherein said support member and said valve stem of said first coupler are coupled such that said valve stem of said first coupler cannot rotate relative to said first coupler; and
wherein a portion of said valve stem of said second coupler is threaded and wherein said support member of said second coupler has a threaded hole operative to receive said threaded portion of said valve stem; and
wherein said fluid line connecting end of each of said first and second couplers is coupled to a fluid line;
b) coupling said first and second couplers by a screw action whereby said coupling ends of said first and second couplers are engaged with one another and said first and second couplers are contrarotated;
wherein, when said first and second couplers are engaged and contrarotated, said coupling head of said first coupler is operative to engage said coupling head of said second coupler and to cause said valve stem of said second coupler to rotate in unison with said first coupler, thereby causing movement of said valve stems of said first and second couplers toward said fluid line connecting end of said first coupler and causing said fluid tight seals between said coupling heads and said mouths of said internal bores to be broken such that said internal bores are placed in fluid communication.
